(19) United States
(12) Patent Application Publication
(10) Pub. No.: US 2002/0192628 A1
(43) Pub. Date: Dec. 19, 2002

(54) Electronic sound generating device for getting and refocusing audience attention

(76) Inventor: Fran Rebello, Chico, CA (US)

Correspondence Address: PARENT PATENT RESEARCH, INC, 600 NORTH PICKETT STREET, ALEXANDRIA, VA, 22304

(21) Appl. No.: 09/881,800

(22) Filed: Jun. 18, 2001

(51) Int. Cl. G09B 5/00

(52) U.S. Cl. 434/308

(57) ABSTRACT

A handheld device that allows lecturers get and hold the attention of an audience. The device emits a loud sound when actuated by the lecturer chosen from a number of pre-determined sounds. A built-in recorder allows the recording of custom sounds including short spoken sentences or phrases. The device also includes auxilliary features such as a timer, a watch, an alarm, and a calendar.

### BACKGROUND OF THE INVENTION

1. Field of Invention

The present invention relates to sound recording and playback devices, and more specifically to such devices which utilize solid-state electronics to store the recorded sounds.

2. Description of Related Art

In the era where presentations and teaching focus on student centered activities and audience participation, lecturers and other presenters have a problem in getting and refocusing the attention of their audience. Business presenters use strategies such as small group discussions, diverting attention from the main speaker. Teachers are encouraged through their training to use student centered activities which allow for interactions among students for specified periods of time. In both cases a unique attention getting device is needed to refocus the audiences. If a sudden, unexpected, relatively loud sound is heard, most persons who were diverted from the lecture will snap to attention and look to see where the sound came from. Such unexpected sounds, startling as they can be, have the effect of quieting groups of people, and focusing their attention on the origin of the sound. Such sounds are also typically random rather than preplanned, except for the occasional lecturer whom raises his or her voice unexpectedly, claps, or otherwise generates a naturally occurring unexpected sound.

Applicant is not aware of any devices that are specifically designed to generate such startling, unexpected sounds for the purpose of getting an audience's attention. However, during a search at the U.S. Patent and Trademark Office, a number of patents were found related to sound recording and playback devices, and such devices that utilize solid-state electronics to store the recorded sounds. In U.S. Pat. No. 3,075,303 issued to Butterfly is disclosed an educational device that plays back portions of a program and then allows a user to answer questions or to respond in a predetermined period of time. In U.S. Pat. No. 3,900,196 issued to Suttner is disclosed a game that involves taping sound effects. In U.S. Pat. No. 3,905,128 issued Koizumi et al. is disclosed a teaching system. As in the '303 patent above, the system plays parts of the course or questions, and allows students a certain period of time reply. In U.S. Pat. No. 4,493,652 issued to Nettle is disclosed an inspirational teaching apparatus that shows an inspirational symbol that appears to steadily increase in size. When the symbol has reached the maximum size, an inspirational phrase is both displayed and played through an audio output. In U.S. Pat. No. 6,029,042 issued Yaron-Moallim is disclosed an educational device having buttons underneath hinged covers with graphical insignia thereon, such as the alphabet. When the buttons are pressed, appropriate sounds, stories, or the like are played. Finally, in U.S. Pat. No. 6,079,985 issued to Wohl et al. is disclosed a programmable device for making sounds and music.

Thus, while many systems have been developed to use prerecorded sounds in a teaching or educational environment, there is a need for a device for allowing a lecturer or other speaker to get and retain the attention of an audience.

### SUMMARY OF INVENTION

### 1. Advantages of the Invention

One of the advantages of the present invention is that it provides a device which immediately gets the attention of an audience.

A further advantage of the present invention is that it provides multiple pre-recorded, pre-determined sounds that are stored in the device.

Another advantage of the present invention is it provides the ability to record custom sounds such as speech, which allows the lecturer to record the desired sounds tailored to specific interests and motivational cues to attract the particular audience's attention and interest.

Another advantage of the present invention is it provides a fixed optimum volume level sufficient for the device to project the chosen sound a sufficient distance so as to fill a classroom or presentation hall with the sound without requiring volume adjustment by the lecturer.

Another advantage of the present invention is the auxiliary features including a clock, a stop watch, an alarm, and a calendar, the alarm which can be set to activate hourly and/or at a specific time to signal the end of a class or other lecture session, and the stopwatch allows the lecturer to monitor the elapsed time during individual or group activities.

Another advantage of the present invention is its compact size convenient for being held in-hand or carried in a cloths pocket.

These and other advantages of the present invention may be realized by reference to the remaining portions of the specification, claims, and abstract.

### 2. Brief Description of the Invention

The present invention is an attention getting device and a method for a lecturer to use to attract and hold the attention of people in a listening audience. The device comprises a microphone adapted to pick up and convert sound waves to an electrical signal, a first logic device which is operatively connected to said microphone for receiving and controlling said electrical signal, an electrical storage device operatively connected to said microphone and said logic device, being adapted for receiving, storing, and outputting the electrical signals, the receiving, storing, and outputting being controlled by said first logic device, and a speaker operatively connected to said first logic device and said electrical storage device adapted to turn outputted electrical signals received from said first logic device and said electrical storage device into audible sound waves.

The method for attracting and holding the attention of the one or more people in a listening audience comprises the steps of providing at least one pre-recorded electronically stored sound, providing a sound generator device adapted for converting the at least one stored sound into sound waves, and operating the sound generator to broadcast one of the stored sounds selected sound into the audience to gain and maintain attention of the audience.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should riot be regarded as limiting.

### BRIEF DESCRIPTION OF THE DRAWINGS

Preferred embodiments of the present invention are shown in the accompanying drawings wherein:

FIG. 1 is substantially a perspective view of an attention getting device according to the invention;

FIG. 2 is substantially an exploded view of the attention getting device; and

FIG. 3 is substantially a schematic circuit diagram showing the circuit features of the attention getting device.

### DESCRIPTION OF THE PREFERRED EMBODIMENT

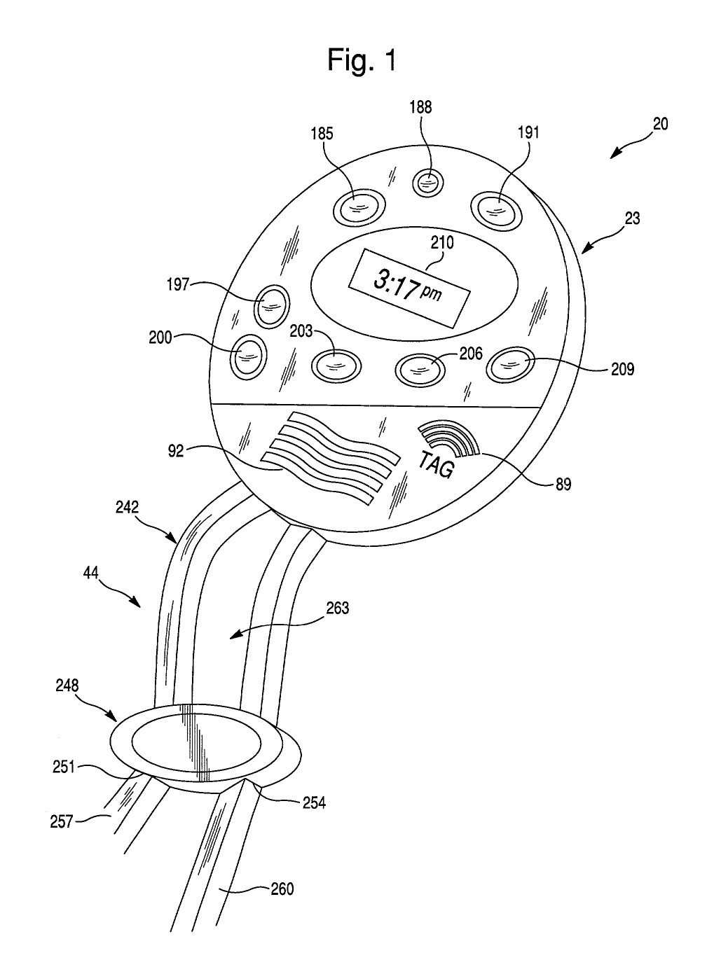

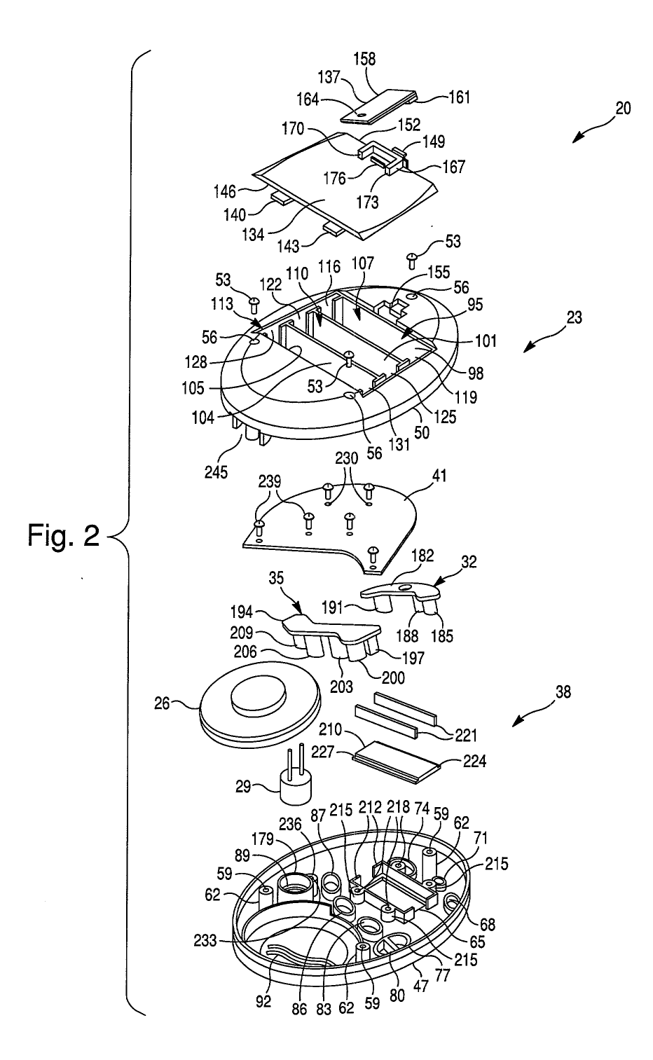

As shown in FIGS. 1 and 2, the present invention is an attention getting device, generally indicated at 20. Attention getting device 20 comprises a housing assembly 23, a speaker 26, a microphone 29, a pair of switch assemblies 32 and 35, a liquid crystal display (LCD) assembly 38, a circuit board 41 and a retaining strap assembly 44.

Housing

The housing assembly 23 is in the form of an oval of such a size to be held in hand. Housing 23 includes a front half shell 47 and a mating rear half shell 50 which connect together using a plurality of screws 53 which extend through respective holes 56 in rear half shell 50 and threadably engage respective threaded holes 59 of respective mounting posts 62 of front half shell 47. Front half shell 47 includes an LCD hole 65, a plurality of switch holes 68, 71, 74, 77, 80, 83, 86, and 87, a plurality of waved microphone slots 89, and a plurality of waved speaker slots 92 which extend through front half shell 47. Rear half shell 50 includes a rectangular battery door hole 95 across which a plurality of battery separation baffles 98, 101, 104, and 105 extend form three separate battery chambers 107, 110, and 113. Respective pairs of electrical contacts (not shown) are disposed within respective pairs of end slots 116 and 119, 122 and 125, 128 and 131 of rear half shell 50 adjacent the respective battery chambers 107, 110, and 113 to conduct electricity from respective AAA batteries (not shown) disposable therein to power attention getting device 20. Housing assembly 23 further includes a battery door 134 and a belt clip 137. A pair of tabs 140 and 143 extend from an edge 146 of battery door 134, being engageable with respective mating slots (not shown) of rear half shell 50. A spring clip 149 extends oppositely from an edge 152 of battery door 134, being engageable with a mating T-slot 155 of rear half shell 50. Tabs 140 and 143, and spring clip 149 engage the respective mating slots and the T-slot 155 to removably secure battery door 134 to rear half shell 50, being disposed within battery door hole 95. Belt clip 137 includes a pair of tabs 158 and 161 which extend laterally from a body 164 of belt clip 137. Battery door 134 includes a U-shaped flange 167 which includes mating grooves 170 and 173 into which tabs 158 and 161 slide. Belt clip 137 is releasably retained in place by a groove (not shown) intermediate tabs 158 and 161, and by a mating elongate projection 176 intermediate grooves 170 and 173.

Speaker

Speaker 26 connects to front half shell 56 directly behind waved slots 92, being retained in position by being sandwiched between front half shell 47 and rear half shell 50.

Microphone

The microphone 29 closely fits within a cylinder 179 which extends inwardly from front half shell 47 coaxially with the microphone hole 89, cylinder 179 being of the same length as microphone 89.

Switch Assemblies

Switch assembly 32 includes a curved base plate 182 from which extend a SET-RESET pushbutton 185, a MODE pushbutton 188, and a START-STOP pushbutton 191 extend. Switch assembly 32 is disposed against front half shell 47 with pushbuttons 185, 188, and 191 extending through the respective switch holes 68, 71, and 74. Switch assembly 35 includes a curved base plate 194 from which extend a REC pushbutton 197, a PLAY pushbutton 200, and three SOUND pushbuttons 203, 206, and 209 extend. Switch assembly 35 is disposed against front half shell 47 with pushbuttons 197, 200, 203, 206, and 209 extending through the respective switch holes 77, 80, 83, 86, and 87.

Liquid Crystal Display Assembly

Liquid crystal display (LCD) assembly 38 includes a liquid crystal display (LCD) 210 which fits within a pair of opposing C-shaped projections 212 extending inwardly from front half shell 47 bordering LCD hole 65. C-shaped projections 212 each include a pair of mounting projections 215 with respective threaded holes 218. A pair of retaining plates 221 engage respective opposing side grooves 224 and 227 of LCD display 210.

Circuit Board

Circuit board 41 contains most of the circuitry (not shown) described below, and includes a plurality of holes 230 therethrough which align with threaded holes 218 of mounting projections 215, and with respective threaded holes 233 of a pair of mounting posts 236 which extend inwardly from front half shell 47. A plurality of screws 239 retain circuit board 41 to front half shell 47, sandwiching speaker 26, microphone 29, switch assemblies 32 and 35, and liquid crystal display (LCD) 210 with retaining plates 221 in position within housing assembly 23.

Retaining Strap Assembly

The retaining strap assembly 44 includes an elongate flexible strap 242 which loops through a U-shaped retaining groove 245 of rear half shell 50, and being retained against front half shell 47. An adjustment slide 248 includes a pair of holes 251 and 254 through which respective end portions 257 and 260 of strap 242 closely pass, having a friction fit requiring some force to move the end portions 257 and 260 through the respective hole 251 and 254. A person's hand (not shown) fits through a loop 263 formed between strap 242, slide 248, and housing assembly 23 to retain the attention getting device 20 around to person's wrist (not shown), slide 248 providing adjustment.

Circuitry

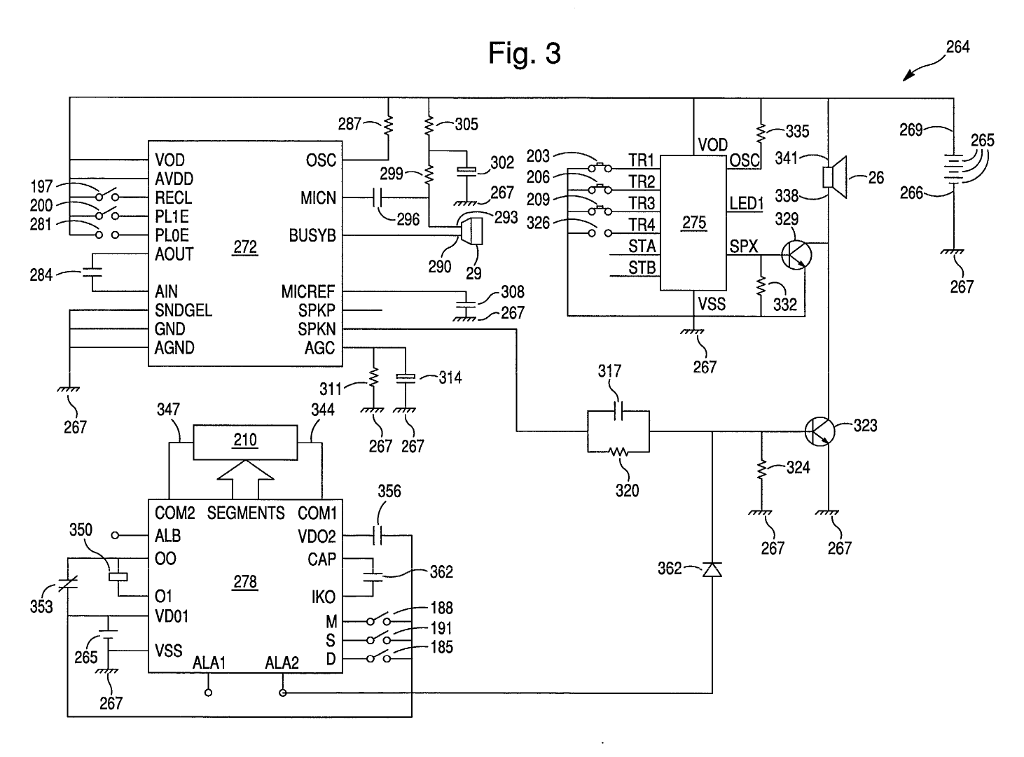

Attention getting device 20 includes circuitry as is generally indicated at 264 in FIG. 3. Circuitry 264 is powered by the three AAA 1.5 volt batteries 265 connected in series to supply 4.5 volts DC from the ground terminal 266 of the series to a ground 267, and includes a positive terminal 269. Microphone 29 provides an input signal to a microprocessor 272 which controls the recording and the playback of sound input through microphone 29, which are stored on a memory chip 275 for later playback through speaker 26. A second microprocessor 278, controls the LCD display 210.

First Microprocessor: Positive terminal 269 is connected directly to respective VDD and AVDD connections of microprocessor 272, through the REC pushbutton 197 to an RECL connection, through PLAY pushbutton 200 to a PL1E connection, and through a fuse/switch 281 to a PL2E connection thereof. An AOUT connection is connected through a capacitor 284 to an AIN connection. Respective SNDSEL, GND, and AGND connections are connected to ground 267. An OCS connection is connected through a resistor 287 to positive terminal 269. A first connection 290 of the microphone 29 is connected to a BUSYB connection of microprocessor 272. A second connection 293 of microphone 29 is connected through a capacitor 296 to a MICIN connection, through a resistor 299 and a capacitor 302 to ground 267, and through resistor 296 and a resistor 305 to the positive terminal 269. A MICREF connection is connected to ground 267 through a capacitor 308. A SPKP connection is available for future use. An AGC connection is connected to ground 267 through a parallel resistor 311 and capacitor 314. A SPKN connection connects to a parallel capacitor 317 and resistor 320, each connected to the base of a first transistor 323, and through a resistor 324 to ground 267. The emitter of transistor 323 is connected to ground 267.

Memory Chip: Positive terminal 269 is connected directly to a VDD connection of memory chip 275. A VSS connection is connected to ground 267. The SOUND pushbuttons 203, 206, and 209 are connected to respective TR1, TR2, and TR3 connections, being connected in parallel along with a switch/fuse 326 to ground 267 and the emitter of a second transistor 329. Respective connections STA, STB, and LED1 are available for future use. The base of transistor 329 is connected through a resistor 332 to the emitter thereof and to an SPK connection of memory chip 275. An OSC connection is connected to the positive terminal 269 through a resistor 335. The collector of transistor 329 is connected to a first connection 338 of speaker 26, and to the collector of transistor 323. A second connection 341 of speaker 26 is connected to positive terminal 269.

Second Microprocessor: A first connection 344 of the LCD display 210 is connected to a COM1 connection of second microprocessor 278, and a second connection 347 of the LCD display 210 is connected to a COM2 connection of microprocessor 278. An OO connection is connected through a capacitor 350 to an OI connection. OO connection is also connected through a variable resistor 353 and a capacitor 356 to a VDD2 connection. A VDD1 connection is connected to the positive terminal of a battery 265, with a negative terminal thereof connected to a VSS connection and to ground 267. VDD1 is also connected through capacitor 356 to VDD2. A CAP connection is connected through a capacitor 362 to a 1KO connection. MODE pushbutton 188, START-STOP pushbutton 191, and SET-RESET pushbutton 185 are connected in parallel from respective M, S, and D connections through capacitor 356 to the VDD2 connection, to the VDD1 connection, through variable resistor 353 to the OO connection, through the variable resistor 353 and capacitor 350 to the OI connection, and to the positive connection of battery 265. An ALA2 connection is connected through a diode 362 to parallel resistor 311 and capacitor 314, to the base of transistor 323, and through resistor 324 to ground 267.

Operation of the Time Based Features of the Attention Getting Device

LCD Display: The LCD display 210 shows the day, month, and time initially for the user, and then is responsible for displaying the clock, the stop watch, alarm, and the hourly announcer.

Setting the Date/Time Features: The MODE button 188, the SET-RESET pushbutton 185 and the START-STOP pushbutton 191 are used to access and adjust each of the functions. Setting the day, the date, and the time is accomplished by pressing the MODE pushbutton 188 repeatedly until the TU (indicating Tuesday) on the days of the week display flashes. The START-STOP pushbutton 191 is then pressed the appropriate number of times to set the second, the minute, the hour, the date, the month, and the day of the week while the SET-RESET pushbutton 185 is used to cycle between these choices. Pressing the MODE pushbutton 188 will then take the user back to the clock display.

Setting the Alarm: Setting the alarm is accomplished by pressing the MODE pushbutton 188 repeatedly until the “MO” (indicating Monday) on the day of the week display starts to flash. The START-STOP pushbutton 191 is then pressed the appropriate number of times to set the hour. The SET-RESET pushbutton 185 is then pressed to switch to minute adjustment, which is also accomplished by pressing the START-STOP pushbutton 191 the appropriate number of times. Pressing the MODE pushbutton 188 will then take the user back to the clock display.

Using the Stopwatch Function: The stopwatch function is used by pressing and holding the MODE pushbutton 188 which causes two symbols representing days of the week to blink. Pressing the START-STOP pushbutton 191 starts the stopwatch running. Pressing the START-STOP pushbutton 191 again stops the stopwatch. If the SET-RESET pushbutton 185 is pressed while the stopwatch is not running, the counter is reset to zero. Pressing the SET-RESET pushbutton 185 while the stopwatch is running pauses the stopwatch. Pressing the START-STOP pushbutton 191 while the counter is paused returns the clock display to the LCD display 210. The clock mode is the default setting on the LCD display 210.

Other Functions: The MODE button 188, the SET-RESET pushbutton 185 and the START-STOP pushbutton 191 are used to access and adjust each of the functions. For example, pressing and holding down the SET-RESET pushbutton 185 displays the currently set time of the alarm on the LCD display 210. Pressing and holding down the START-STOP pushbutton 191 displays the date and month on the LCD display 210. Pressing and holding the SET-RESET pushbutton 185, then pressing and holding the START-STOP pushbutton 191 (holding both of them down) displays the currently set time on the alarm on the LCD display 210, and plays the sound of an alarm through the speaker 26. Pressing the START-STOP pushbutton 191 at this point turns the alarm on or off, with a small bell being displayed on the LCD display 210 when the alarm is set. Pressing and holding the SET-RESET pushbutton 185, the START-STOP pushbutton 191, and the MODE pushbutton 188 in that order causes cycling the functions on the LCD display 210, with the alarm sounding continuously.

Operation of the Sound Based Features of the Attention Getting Device

Pre-recorded Sounds: Located under the LCD display 210 are the three SOUND pushbuttons 203, 206, and 209. These are also labeled within the indicia “1”, “2”, and “3” on the front half shell 47 of housing assembly 23. Each causes a specific predetermined sound to play through the speaker 26. The volume of the sound is preset to an optimum attention-getting decibel level for typical places where the attention getting device 20 will be used. For example, pressing SOUND pushbutton 203 might play the sound of cars racing on a track. Pressing SOUND pushbutton 206 might plays the sound of a rooster crowing. Pressing SOUND pushbutton 209 might play the well-known sound commonly called the “Tarzan yell”. There can be a timed duration of play for one or more of the sounds even when the respective SOUND pushbutton 203, 206, or 209 is released such as thirty seconds or some other duration thought effective in getting attention. Each sound can be played at the same volume level, or each can have its own preset decibel level. Each sound played has the ability to attract the attention of a group of people if they are played at an appropriate volume. It should be emphasized that any number of sounds could be utilized in this device and they could be of a wide variety. Cartoon voices, certain synthesized tones, certain motivational phrases, and the like could be pre-recorded into the attention getting device 20. It should be noted that although only three SOUND pushbuttons 203, 206, and 209 are shown so as to play three pre-determined sounds, more or less could be provided.

Recording Custom Sounds: Another feature of the present invention is the ability to record the desired sounds, including spoken words, through the microphone 29. This is accomplished by pressing and releasing the REC pushbutton 197 while directing the microphone 29 toward the sound to be recorded. The recording may be stopped either by again pressing and releasing the REC pushbutton 197, or by waiting until a predetermined maximum recording time has been reached, such as for example eight seconds. The recorded sound can be played back by pressing the PLAY pushbutton 200.

### CONCLUSION

It can now be seen that the present invention solves many of the problems associated with the prior art. The present invention provides a device that immediately gets the attention of an audience. The present invention provides multiple pre-recorded, pre-determined sounds that are stored in the device. The present invention provides the ability to record custom sounds such as speech, which allows the lecturer to record the desired sounds tailored to specific interests and motivational cues to attract the particular audience's attention and interest. The present invention provides a fixed optimum volume level sufficient for the device to project the chosen sound a sufficient distance so as to fill a classroom or presentation hall with the sound without requiring volume adjustment by the lecturer. The present invention provides auxiliary features including a clock, a stop watch, an alarm, and a calendar, the alarm which can be set to activate hourly and/or at a specific time to signal the end of a class or other lecture session, and the stopwatch allows the lecturer to monitor the elapsed time during individual or group activities. The present invention provides a device of a compact size convenient for being held in-hand or carried in a cloths pocket.

Although the description above contains many specifications, these should not be construed as limiting the scope of the invention but as merely providing illustrations of some of presently preferred embodiments of this invention. The specification, for instance, makes reference to a portable, handheld device. However, the device could be built into a podium from which the lectures are given so as not to be portable. The device could also be removably mountable by means of a mounting bracket, such as for storage in the podium when not in use. Likewise, changes to the various auxiliary functions, adding more, or deleting functions is contemplated within the scope of the invention.

What is claimed is:

1. An attention getting device for a lecturer to use to attract and hold the attention of people in a listening audience, comprising:
a microphone adapted to pick up and convert sound waves to an electrical signal;
a first logic device which is operatively connected to said microphone for receiving and controlling said electrical signal;
an electrical storage device operatively connected to said microphone and said logic device, being adapted for receiving, storing, and outputting the electrical signals, the receiving, storing, and outputting being controlled by said first logic device; and
a speaker operatively connected to said first logic device and said electrical storage device adapted to turn outputted electrical signals received from said first logic device and said electrical storage device into audible sound waves.

2. The attention getting device of claim 1, further comprising a housing adapted for containing the microphone, the logic device, electrical storage device, and the speaker.

3. The attention getting device of claim 2, wherein the housing is of such a configuration and size as to be held in one hand.

4. The attention getting device of claim 2, further comprising a plurality of switches adapted to control respective recording and play functions of the logic device.

5. The attention getting device of claim 2, wherein the electrical storage device has stored at least one pre-determined sound.

6. The attention getting device of claim 5, wherein there are a plurality of pre-determined sounds stored in the electrical storage device.

7. The attention getting device of claim 2, wherein the electrical storage device segregates individual sounds for individual playback, and wherein the individual playback is controlled by a plurality of switches, each being adapted to control the individual playback of one individual sound.

8. The attention getting device of claim 2, further comprising:
a second logic device which is operatively connected to the first logic device, the microphone, the speaker, and the electrical storage device; and
a display which is operatively connected to and controlled by said second logic device, said display being adapted to show at least one function of the attention getting device.

9. The attention getting device of claim 8, wherein the display comprises a liquid crystal display.

10. The attention getting device of claim 2, further comprising a retaining strap connectable to the housing for attachment around a wrist of the lecturer.

11. The attention getting device of claim 10, wherein the retaining strap includes an adjustable slide to form a larger or smaller loop around the wrist.

12. A method for attracting and holding the attention of the one or more people in a listening audience, comprising the steps of:
providing at least one pre-recorded electronically stored sound;
providing a sound generator device adapted for converting the at least one stored sound into sound waves;
operating the sound generator to broadcast one of the stored sounds selected sound into the audience to gain and maintain attention of the audience.

13. The method of claim 12, wherein the sound generator device broadcasts the stored sound only for a predetermined period of time.

14. The method of claim 12, wherein a sound recorder and a microphone allow the recording of custom sounds for later playback, and the method includes the steps of recording a custom sound, storing the custom sound, and broadcasting the custom sound.
